(19) United States
(12) Patent Application Publication
(10) Pub. No.: US 2020/0342896 A1
(43) Pub. Date: Oct. 29, 2020

(54) CONFERENCE SUPPORT DEVICE, CONFERENCE SUPPORT SYSTEM, AND CONFERENCE SUPPORT PROGRAM

(71) Applicant: KONICA MINOLTA, INC., Tokyo (JP)

(72) Inventor: Kazuaki KANAI, Tokyo (JP)

(73) Assignee: KONICA MINOLTA, INC., Tokyo (JP)

(21) Appl. No.: 16/839,150

(22) Filed: Apr. 3, 2020

(30) Foreign Application Priority Data
Apr. 23, 2019 (JP) 2019-082225

(51) Int. Cl. G10L 25/63; G10L 15/26; G06K 9/00; H04N 7/15

(52) U.S. Cl. CPC G10L 25/63; G10L 15/265; H04N 7/15; G06K 9/00302; G06K 9/00711

(57) ABSTRACT

A conference support device includes: a voice input part to which voice of a speaker among conference participants is input; a storage part that stores a voice recognition model corresponding to human emotions; a hardware processor that recognizes an emotion of the speaker and converts the voice of the speaker into a text using the voice recognition model corresponding to the recognized emotion; and an output part that outputs the converted text.

The entire disclosure of Japanese patent Application No. 2019-082225, filed on Apr. 23, 2019, is incorporated herein by reference in its entirety.

### BACKGROUND

Technological Field

### The present invention relates to a conference support device, a conference support system, and a conference support program.

### Description of the Related art

In the related art, a video conference using communication has been known in order to have a conference between persons at distant positions. In the video conference, images and voices can be exchanged in both directions.

In the video conference, a system is known which converts a voice into a text and displays subtitles in order to make the speech of a speaker easier to understand. In such conversion of a voice to a text, a voice recognition technology is used.

As a conventional voice recognition technology, for example, in JP 2002-230485 A, when a foreign language speech model stored in a memory is replaced according to pronunciation similarity data, recognition accuracy can be improved even when there is an ambiguity or an error in pronunciation specific to the utterance of a non-native speaker.

Also, for example, in the field of character recognition, JP 10-254350 A is disclosed as a technique for increasing the character recognition rate by a change in human emotions. In JP 10-254350 A, the emotion of a user is recognized based on voice data input from a voice input part, and a dictionary for recognizing a handwritten character input is switched according to the recognized emotional state. As a result, in JP 10-254350 A, when the emotional state of the user is unstable and handwriting input is complicated, the number of candidate characters is increased compared to the normal case.

Incidentally, a person changes the loudness and pitch of a voice and speech patterns according to emotions, for example, joy, anger, grief, and pleasure. In JP 2002-230485 A, the recognition accuracy is improved with respect to an ambiguity and an error in pronunciation specific to the utterance of a non-native speaker. However, in JP 2002-230485 A, the changes in utterance caused by joy, anger, grief, and pleasure are not considered, and it is impossible to cope with recognition errors caused by human emotions.

In addition, the technique of JP 10-254350 A is only a technique in the field of character recognition although the technique considers the emotional state of a person. Moreover, the technique is merely adding conversion character candidates to match the emotion of the person. For this reason, in JP 10-254350 A, it is impossible to cope with the use of recognizing a voice in real time immediately after utterance and converting the voice into a text as in a video conference.

### SUMMARY

Therefore, an object of the present invention is to provide a conference support device, a conference support system, and a conference support program that can increase conversion accuracy from voices to texts in response to an emotion of a speaker during a conference.

To achieve the abovementioned object, according to an aspect of the present invention, a conference support device reflecting one aspect of the present invention comprises: a voice input part to which voice of a speaker among conference participants is input; a storage part that stores a voice recognition model corresponding to human emotions; a hardware processor that recognizes an emotion of the speaker and converts the voice of the speaker into a text using the voice recognition model corresponding to the recognized emotion; and an output part that outputs the converted text.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating a configuration of a conference support system according to an embodiment of the present invention;

FIG. 2 is a flowchart illustrating a procedure of conference support by the conference support system;

FIG. 3 is a functional block diagram for explaining a voice recognition process;

FIG. 4 is a diagram illustrating an outline of an emotion recognition method from a voice extracted from the document “Recognition of Emotions Included in Voice”;

FIG. 5A is a voice waveform diagram illustrating an example of correcting voice data when the emotion is anger;

FIG. 5B is a voice waveform diagram illustrating an example of correcting voice data when the emotion is anger; and

FIG. 6 is an explanatory diagram illustrating a configuration of a conference support system in which three or more computers are connected by communication.

### DETAILED DESCRIPTION OF EMBODIMENTS

Hereinafter, one or more embodiments of the present invention will be described with reference to the drawings. However, the scope of the invention is not limited to the disclosed embodiments.

In the drawings, the same elements or members having the same functions will be denoted by the same reference symbols, and redundant description is omitted. In addition, the dimensional ratios in the drawings may be exaggerated for convenience of description, and may be different from the actual ratios.

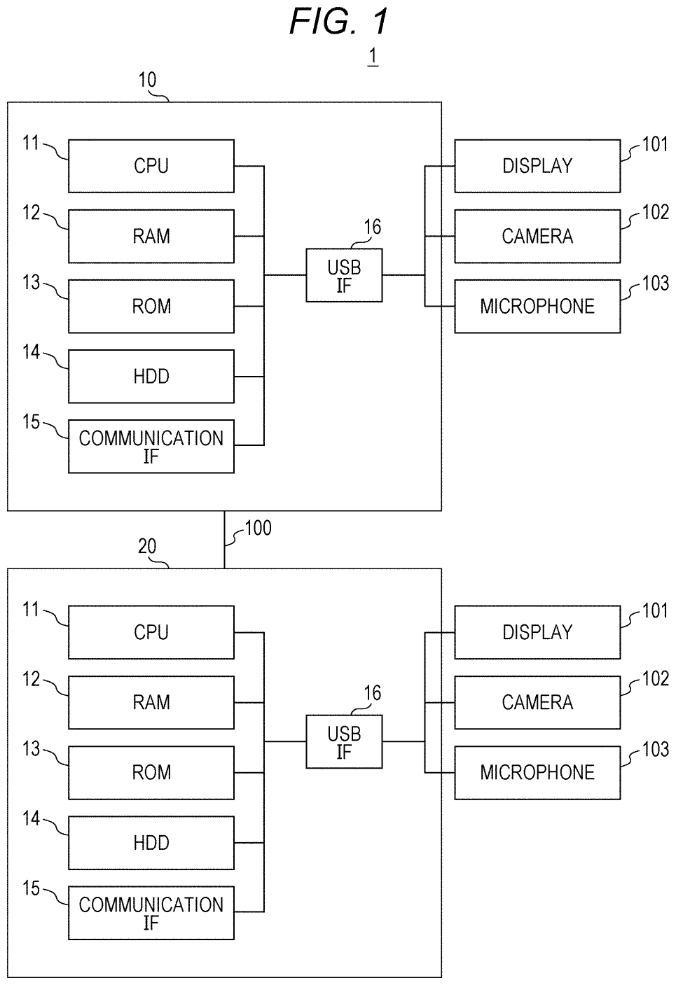

FIG. 1 is a block diagram illustrating a configuration of a conference support system according to an embodiment of the present invention.

A conference support system 1 according to the embodiment is a so-called video conference system in which a conference participant in a remote place can hold a conference while watching a television (display) connected by communication.

The conference support system 1 includes a first computer 10 and a second computer 20 connected via a network 100. In this embodiment, the first computer 10 and the second computer 20 each function as a conference support device.

A display 101, a camera 102, and a microphone 103 are all connected to the first computer 10 and the second computer 20. Hereinafter, when the first computer 10 and the second computer 20 are not distinguished, the computers are simply referred to as a computer.

The computer is a so-called personal computer (PC). The internal configuration of the computer includes, for example, a central processing unit (CPU) 11, a random access memory (RAM) 12, a read only memory (ROM) 13, a hard disk drive (HDD) 14, a communication interface (interface (IF)) 15, and a universal serial bus (USB) interface (IF).

The CPU 11 controls each part and performs various arithmetic processes according to a program. Therefore, the CPU 11 functions as a control part.

The RAM 12 temporarily stores programs and data as a work area. Therefore, the RAM 12 functions as a storage part.

The ROM 13 stores various programs and various data. The ROM 13 also functions as a storage part.

The HDD 14 stores data of an operating system, a conference support program, and a voice recognition model (described in detail later), and the like. The voice recognition model stored in the HDD 14 can be added later. Therefore, the HDD 14 functions as a storage part together with the RAM 12. After the computer is actuated, the programs and data are read out to the RAM 12 and executed as needed. Note that a nonvolatile memory such as a solid state drive (SSD) may be used instead of the HDD 14.

The conference support program is installed on both the first computer 10 and the second computer 20. The functional operations performed by the conference support program are the same for both computers. The conference support program is a program for causing a computer to perform voice recognition in accordance with human emotions.

The communication interface 15 transmits and receives data corresponding to the network 100 to be connected.

The network 100 is, for example, a local area network (LAN), a wide area network (WAN) connecting LANs, a mobile phone line, a dedicated line, or a wireless line such as wireless fidelity (WiFi). The network 100 may be the Internet connected by a LAN, a mobile phone line, or WiFi.

The display 101, the camera 102, and the microphone 103 are connected to a USB interface 16. The connection with the display 101, the camera 102, and the microphone 103 is not limited to the USB interface 16. For connection with the camera 102 and the microphone 103, various interfaces can be used also on the computer side in accordance with the communication interface and connection interface provided therein.

Although not illustrated, for example, a pointing device such as a mouse and a keyboard are connected to the computer.

The display 101 is connected by the USB interface 16 and displays various videos. For example, a participant on the second computer 20 side is displayed on the display 101 of the first computer 10 side, and a participant on the first computer 10 side is displayed on the display 101 of the second computer 20 side. In addition, on the display 101, for example, a participant on the own side is displayed on a small window of the screen. Also, on the display 101, the content of the speech of the speaker is displayed as subtitles. Therefore, the USB interface 16 is an output part for displaying text as subtitles on the display 101 by the processing of the CPU 11.

The camera 102 photographs a participant and inputs video data to a computer. The number of cameras 102 may be one, or a plurality of cameras 102 may be used to photograph the participants individually or for several persons. The video from the camera 102 is input to the first computer 10 via the USB interface 16. Therefore, the USB interface 16 is a video input part for inputting video from the camera 102.

The microphone 103 (hereinafter, referred to as a microphone 103) collects speech (utterance) of a participant, converts the speech into an electric signal, and inputs the signal to the computer. One microphone 103 may be provided in the conference room, or a plurality of microphones 103 may be provided for each participant or for several persons. The voice from the microphone 103 is input to the first computer 10 via the USB interface 16. Therefore, the USB interface 16 is a voice input part for inputting voice from the microphone 103.

A procedure for conference support by the conference support system 1 will be described.

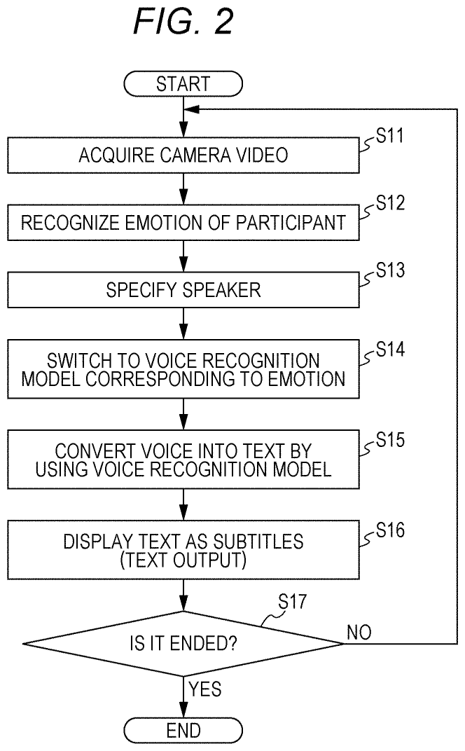

FIG. 2 is a flowchart illustrating a procedure of conference support by the conference support system 1. Hereinafter, a case where the program based on this procedure is executed by the first computer 10 will be described. However, the same applies to a case where the program is executed by the second computer 20.

First, the CPU 11 in the first computer 10 acquires video data from the camera 102 (S11). Hereinafter, in the description of this procedure, the CPU 11 in the first computer 10 will be simply referred to as the CPU 11.

Subsequently, the CPU 11 identifies the face of the participant from the video data and recognizes the emotion from the facial expression of the participant (S12). The process of recognizing emotions from facial expressions will be described later.

Subsequently, the CPU 11 specifies the speaker from the video data and acquires the voice data from the microphone 103 to store the voice data in the RAM 12 (S13). For example, the CPU 11 recognizes the face of a participant from the video data and specifies that the participant is a speaker if the mouth is continuously opened and closed for, for example, one second or more. The time for specifying the speaker is not limited to one second or more, and may be any time as long as the speaker can be specified from the opening/closing of the mouth or the facial expression of the person. When the microphone 103 with a speech switch is prepared for each individual participant, the CPU 11 may specify a participant in front of the microphone 103 with the switch turned on as a speaker.

The processes of S12 and S13 are performed, for example, as follows. When there are a plurality of participants, the CPU 11 recognizes the emotion of each of the plurality of participants in S12. Thereafter, the CPU 11 specifies the speaker in S13, and associates the emotions of the plurality of participants recognized in S12 with the specified speaker.

The execution order of each step of S12 and S13 may be reversed. In the case of the reverse order, the CPU 11 specifies the speaker first (S13), and thereafter recognizes the emotion of the specified speaker (S12).

Subsequently, the CPU 11 switches to the voice recognition model corresponding to the emotion of the speaker (S14). The voice recognition model is read into the RAM 12, and the CPU 11 switches the used voice recognition model according to the recognized emotion.

In order to perform a text conversion in real time, it is preferable that all the voice recognition models for respective emotions are read from the HDD 14 to the RAM 12 when the conference support program is started. However, if the HDD 14 or other non-volatile memory that stores the voice recognition model can be read at a high speed enough to support real-time subtitle display, the voice recognition model corresponding to the recognized emotion may be read from the HDD 14 or other nonvolatile memories in step S14.

Subsequently, the CPU 11 converts voice data into text data using the voice recognition model (S15).

Subsequently, the CPU 11 displays the text of the text data on the display 101 of the first computer 10 as subtitles, and transmits the text data from the communication interface 15 to the second computer 20 (S16). The communication interface 15 serves as an output part when the text data is transmitted to the second computer 20. The second computer 20 displays the text of the received text data on its own display 101 as subtitles.

Thereafter, if there is an instruction to end the conference support, the CPU 11 ends this procedure (S17: YES). If there is no instruction to end the conference support (S17: NO), the CPU 11 returns to S11 and continues this procedure.

Next, a process of recognizing the emotion of the participant from video data will be described.

Human emotions can be recognized by a facial expression description method. An existing program can be used as the facial expression description method. As a program of the facial expression description method, for example, a facial action coding system (FACS) is used. The FACS defines an emotion in an action unit (AU), and recognizes human emotion by pattern matching between the facial expression of the person and the AU.

The FACS is disclosed, for example, in “Facial expression analysis system using facial feature points”, Chukyo University Shirai Laboratory, Takashi Maeda, Reference URL=http://lang.sist.chukyo-u.acjp/Classes/seminar/Papers/2018/T214070_yokou.pdf.

According to the technique of the above-described document “Expression analysis system using facial feature points”, an AU code in Table 1 below is defined, and as shown in Table 2, the AU code corresponds to the facial expression. Incidentally, Tables 1 and 2 are excerpts from the above-described document “Facial expression analysis system using facial feature points”.

TABLE 1

| AU No. | FACS Name |
|---|---|
| AU1 | Lift inside of eyebrows |
| AU2 | Lift outside of eyebrows |
| AU4 | Lower eyebrows to inside |
| AU5 | Lift upper eyelid |
| AU6 | Lift cheeks |
| AU7 | Strain eyelids |
| AU9 | Wrinkle nose |
| AU10 | Lift upper lip |
| AU12 | Lift lip edges |
| AU14 | Make dimple |
| AU15 | Lower lip edges |
| AU16 | Lower lower lip |
| AU17 | Lift lip tip |
| AU20 | Pull lips sideways |
| AU23 | Close lips tightly |
| AU25 | Open lips |
| AU26 | Lower chin to open lips |

TABLE 2

| Basic Facial | |
|---|---|
| Expression | Combination and Strength of AU |
| Surprise | AU1-(40), 2-(30), 5-(60), 15-(20), 16-(25), 20-(10), 26-(60) |
| Fear | AU1-(50), 2-(10), 4-(80), 5-(60), 15-(30), 20-(10), 26-(30) |
| Disgust | AU2-(60), 4-(40), 9-(20), 15-(60), 17-(30) |
| Anger | AU2-(30), 4-(60), 7-(50), 9-(20), 10-(10), 20-(15), 26-(30) |
| Joy | AU1-(65), 6-(70), 12-(10), 14-(10) |
| Sadness | AU1-(40), 4-(50), 15-(40), 23-(20) |

Other techniques of FACS are disclosed, for example, in “Facial expression and computer graphics”, Niigata University Medical & Dental Hospital, Special Dental General Therapy Department, Kazuto Terada et al., Reference URL=http://dspacelib.niigata-u.acjp/dspace/bitstream/10191/23154/1/NS_30 (1)_75-76.pdf. According to the disclosed technique, an emotion can be defined by 44 action units (AU), and the emotion can be recognized by pattern matching with the AU.

In this embodiment, for example, anger, disdain, disgust, fear, joy, neutrality, sadness, and surprise are recognized using these techniques of the FACS.

In addition, the emotion of the participant may be recognized using, for example, machine learning or deep learning using a neural network. Specifically, a lot of teacher data is created in advance that associates human face images with emotions to train the neural network, and the emotions of the participants are output by inputting the face images of the participant to the learned neural network. As the teacher data, data in which the face images of various facial expressions of various people are associated with respective emotions is used. As the teacher data, it is preferable to use, for example, about 10,000 hours of video data.

Next, the voice recognition will be described.

In the voice recognition, an acoustic model and a language model are used as a voice recognition model. In the voice recognition, these models are used to convert voice data into a text.

The acoustic model represents the characteristics of the frequency of a phoneme. Even for the same person, a fundamental frequency changes depending on the emotion. As a specific example, for example, the fundamental frequency of the voice uttered when the emotion is anger is higher or lower than the fundamental frequency when the emotion is neutrality.

The language model represents restrictions on the arrangement of phonemes. As for the relationship between the language model and the emotion, for example, the connection of phonemes differs depending on the emotion. As a specific example, for example, in the case of anger, there is a connection such as “what”→“noisy”, but the connection such as “what”→“thank you” is extremely small. Specific examples of such an acoustic model and a language model are merely simplified for the sake of explanation. In practice, the models are created when the neural network is trained using a large amount of teacher data by machine learning or deep learning using the neural network.

For this reason, in this embodiment, both the acoustic model and the language model are created for each emotion by machine learning or deep learning using the neural network. In the learning for creating the acoustic model and the language model, for example, data in which the voices of various emotions of various people are associated with correct texts is used as the teacher data. As the teacher data, it is preferable to use, for example, about 10,000 hours of voice data.

In this embodiment, the acoustic model and the language model are created for each emotion as shown in Table 3.

TABLE 3

| Emotion | Anger | Disdain | Disgust | Fear |
|---|---|---|---|---|
| Acoustic model | Acoustic model 1 | Acoustic model 2 | Acoustic model 3 | Acoustic model 4 |
| Language model | Language model 1 | Language model 2 | Language model 3 | Language model 4 |
| Emotion | Joy | Neutrality | Sadness | Surprise |
| Acoustic model | Acoustic model 5 | Acoustic model 6 | Acoustic model 7 | Acoustic model 8 |
| Language model | Language model 5 | Language model 6 | Language model 7 | Language model 8 |

The created acoustic model and language model are stored in the HDD 14 or another nonvolatile memory in advance.

The acoustic model and the language model are used corresponding to the emotions in S14 and S15 described above. Specifically, for example, when an emotion of anger is recognized, the acoustic model 1 and the language model 1 are used. Further, for example, when an emotion of sadness is recognized, the acoustic model 7 and the language model 7 are used. The same applies to other emotions.

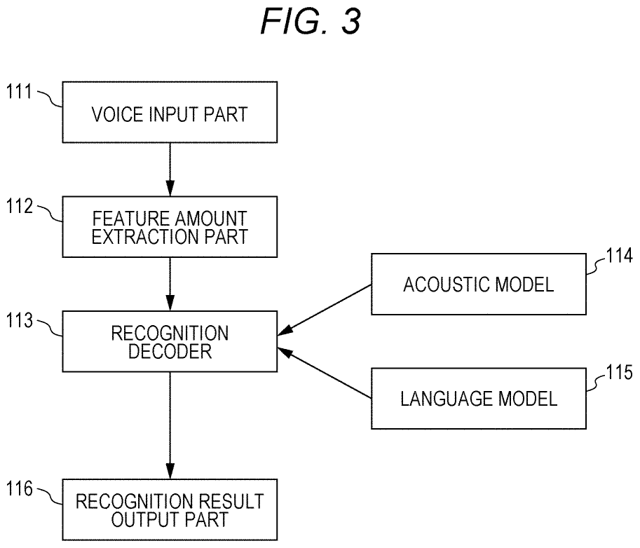

FIG. 3 is a functional block diagram for explaining a voice recognition process.

In the voice recognition, as illustrated in FIG. 3, after a voice input part 111 receives an input of a voice waveform, a feature amount extraction part 112 extracts a feature amount of the input voice waveform. The feature amount is an acoustic feature amount defined in advance for each emotion, and includes, for example, a pitch (fundamental frequency), loudness (sound pressure level (power)), duration, formant frequency, and spectrum of the voice. The extracted feature amount is passed to a recognition decoder 113. The recognition decoder 113 converts the feature amount into a text using an acoustic model 114 and a language model 115. The recognition decoder 113 uses the acoustic model 114 and the language model 115 corresponding to the recognized emotion. A recognition result output part 116 outputs the text data converted by the recognition decoder 113 as a recognition result.

As described above, in this embodiment, since the frequency characteristics of the input voice data change depending on the emotion, this change is used to change the conversion result from the voice data to the text data.

As described above, in this embodiment, since the acoustic model 114 and the language model 115 are switched for each human emotion to recognize a voice and convert the voice speech to a text, erroneous conversion due to differences in human emotion can be reduced.

In this embodiment, eight emotions of anger, disdain, disgust, fear, joy, neutrality, sadness, and surprise are recognized, but more emotions may be recognized Further, at least any two emotions of these eight may be recognized For example, any two emotions are a combination of emotions, which appear to occur frequently during the conference, such as anger and neutrality, joy and neutrality, sadness and neutrality and a combination of an emotion which has a large change in facial expression and is easy to recognize and an emotion in a normal state, which has a little change in facial expression and is difficult to recognize, such as neutrality. Of course, in addition to the examples, various numbers and combinations of emotions can be recognized

### First Modification of Embodiment

In a first modification of the embodiment (hereinafter, a first modification), emotions are recognized from voices. In the first modification, the configuration of the conference support system 1 and the procedure of the conference support (conference support program) are the same as those of the embodiment.

In the first modification, at first, an emotion is recognized from the video data, and a speaker is specified. Thereafter, in the first modification, when voice data for one second is collected after the utterance of the speaker, switching to emotion recognition from the voice data is performed. This is because the emotion of the speaker is unknown before or immediately after the speech of the conference participant (less than one second), so that the emotion of the speaker is recognized from the video of the camera 102. Thereafter, the speaker is specified, and the emotion is also recognized. Thus, the voice data of the speaker is collected, and the emotion of the speaker is recognized only from the voice data.

For the emotion recognition from such voice data, specifically, an existing technique can be used which is disclosed, for example, in “Recognition of Emotions Included in Voice”, Osaka Institute of Technology, Faculty of Information Science, Motoyuki Suzuki, Reference URL=https://wwwj stage.jst.go.jp/article/jasj/71/9/71_KJ00010015073/_pdf.

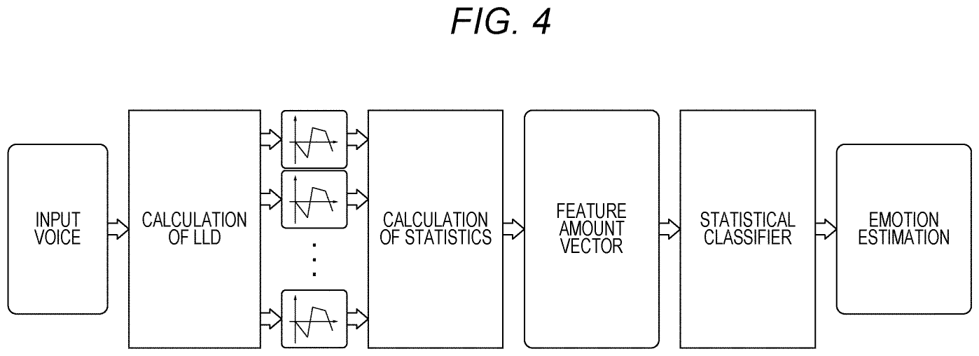

FIG. 4 is a diagram illustrating an outline of an emotion recognition method from a voice extracted from the above-described document “Recognition of Emotions Included in Voice”.

In this emotion recognition method, as illustrated in FIG. 4, a low-level descriptors (LLD) is calculated from an input voice. The LLD is a pitch (fundamental frequency), loudness (power), or the like of the voice. Since the LDD is obtained as a time series, various statistics are calculated from the LLD. The statistics are, specifically, an average value, a variance, a slope, a maximum value, a minimum value, and the like. The input voice becomes a feature amount vector by calculating the statistics. The feature amount vector is recognized as an emotion by a statistical classifier or a neural network (estimated emotion illustrated in the drawing).

As described above, in the first modification, the emotion of the speaker is first recognized from the facial expression, but thereafter, the emotion is recognized from the voice of the speaker. As a result, in the first modification, for example, even when the camera 102 cannot capture the facial expression, the emotion of the speaker can be continuously obtained, and appropriate voice recognition can be performed. Also, in the first modification, since the emotion of the speaker is initially recognized from the facial expression, the recognition accuracy of the emotion is higher than that in a case where the emotion is recognized only by the voice.

In the first modification, the loudness (sound pressure level) of the input voice at the time of voice recognition may be corrected. The correction of the sound pressure level of the input voice is performed by the CPU 11 (control part).

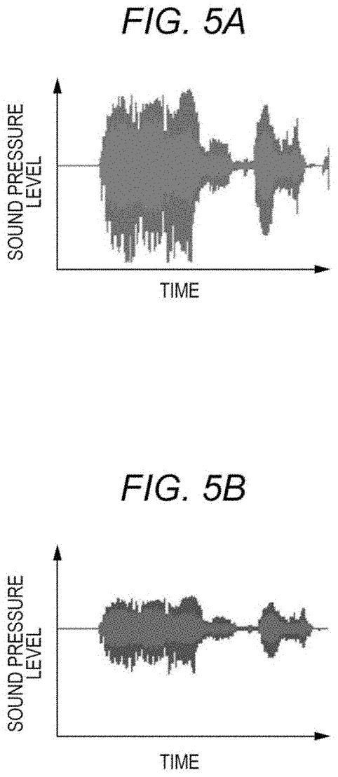

For example, the loudness of the voice can be considered to be large when the emotion is anger, and thus, the sound pressure level at the time of input is corrected to be small. FIGS. 5A and 5B are voice waveform diagrams illustrating an example of correction of voice data when the emotion is anger. In FIGS. 5A and 5B, the horizontal axis represents time, and the vertical axis represents sound pressure level. The scale of time and sound pressure level is the same in the drawings.

As illustrated in FIG. 5A, the voice data at the time of the emotion of anger has a high sound pressure level as it is. Therefore, in such a case, voice recognition is input with the sound pressure level reduced as illustrated in FIG. 5B. Accordingly, it is possible to prevent the sound pressure level of the input voice from being too high to be recognized

Conversely, in a case where the sound pressure level of the input voice is low, the correction of the sound pressure level of the input voice may be made to increase the sound pressure level.

In the description of the first modification, the voice data is collected for one second after the utterance, but such time is not particularly limited. The time for collecting the voice data may be any time as long as emotion recognition can be performed from the voice data.

Further, in the first modification, for example, the voice data is collected for one second from the utterance, and the collection of the voice data continues while the camera 102 captures the face (facial expression). However, the emotion may be recognized from the facial expression, and at the stage where the camera 102 cannot capture the face (facial expression), switching to the emotion recognition using voice data may be performed.

### Second Modification of Embodiment

A second modification of the embodiment (hereinafter, second modification) uses a conference support system 3 in which three or more computers are connected by communication. In the second modification, the configuration of the conference support system 3 differs from the above embodiment in that three or more computers are used, but the other configurations are the same. The procedure of the conference support (conference support program) is the same as that of the embodiment.

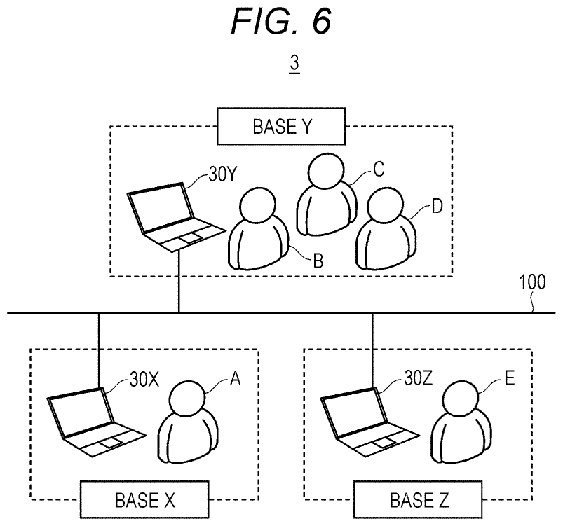

FIG. 6 is an explanatory diagram illustrating the configuration of the conference support system 3 in which three or more computers are connected by communication.

As illustrated in FIG. 6, the conference support system 3 according to the second modification includes a plurality of user terminals 30X, 30Y, and 30Z. The user terminals 30X, 30Y, and 30Z are all the same as the computers described above. FIG. 6 illustrates a laptop computer in shape.

The plurality of user terminals 30X, 30Y, and 30Z are arranged at the plurality of bases X, Y, and Z. The user terminals 30X, 30Y, and 30Z are used by a plurality of users A, B, . . . , E. The user terminals 30X, 30Y, and 30Z are communicably connected to each other via the network 100 such as a LAN.

In the second modification, the conference support program described above is installed in the user terminals 30X, 30Y, and 30Z.

In this second modification configured in this manner, a conference in which three bases X, Y, and Z are connected is made possible, and the subtitles properly voice-recognized according to the emotion of the speaker are displayed in each of the user terminals 30X, 30Y and 30Z.

In the second modification, three bases are connected. However, in a similar manner, a form in which a plurality of bases, that is, a plurality of computers are connected can be implemented.

As described above, the embodiment and the modifications of the present invention have been described, but the present invention is not limited to the embodiment and the modifications.

In the above-described conference support system, a conference support program is installed in each of a plurality of computers, and each computer has a video conference support function. However, the present invention is not limited to this.

For example, the conference support program may be installed only on the first computer 10, and the second computer 20 may communicate with the first computer 10. In this case, the second computer 20 receives the video data from the first computer 10 and displays the video data on the display 101 connected to the second computer 20. The text data obtained by the text conversion is also included in the video data from the first computer 10. In this case, the second computer 20 transmits the video data and the voice data collected by the camera 102 and the microphone 103 connected to the second computer 20 to the first computer 10. The first computer 10 handles video data and voice data from the second computer 20 in the same manner as data from the camera 102 and the microphone 103 connected to the first computer 10 itself. As described in the embodiment, the first computer 10 performs recognition of the emotion of the participant on the second computer 20 side and voice recognition.

In this case, only the first computer 10 serves as a conference support device, and the communication interface 15 of the first computer 10 and the second computer 20 serve as the voice input part and the video input part which input the voice and the video from the second computer 20 to the first computer 10. Further, the communication interface 15 of the first computer 10 serves as an output part for outputting the text into the second computer 20.

Also in a case where the conference support system is configured by three or more computers as in the second modification, any one computer may function as the conference support device in the same way.

Further, the conference support system may be in a form that is not connected to another computer. In the conference support system, the conference support program may be installed in one computer and used in one conference room, for example.

Further, the computer is exemplified by a PC, but may be, for example, a tablet terminal or a smartphone. Since the tablet terminal or the smartphone includes the display 101, the camera 102, and the microphone 103, these functions can be used as they are to configure the conference support system. When a tablet terminal or smartphone is used, the tablet terminal or smartphone displays video and subtitles on its own display 101, photographs the conference participant with the camera 102, and collects voices with the microphone 103.

The conference support program may be executed by a server to which a PC, a tablet terminal, a smartphone, or the like is connected. In this case, the server is a conference support device, and the conference support system is configured to include the PC, the tablet terminal, and the smartphone connected to the server. In this case, the server may be a cloud server, and each tablet terminal or smartphone may be connected to the cloud server via the Internet.

In addition, the voice recognition model is not only stored in the HDD 14 in one or more computers configuring the conference support system, but also may be stored, for example, in a server (including a network server, a cloud server, or the like) on the network 100 to which the computers are connected. In that case, the voice recognition model is read out from the server to the computers as needed to be used. Also, the voice recognition model stored in the server can be added or updated.

In the first modification, the emotion is recognized from the voice after the emotion is recognized from the video. Instead, the emotion may be recognized only from the voice. In this case, the camera 102 becomes unnecessary. Further, as a conference support procedure, emotion recognition from voice is performed instead of the step of emotion recognition from video (image) being unnecessary.

Further, in the embodiment, the control part automatically recognizes the emotion of the speaker, and uses the voice recognition model corresponding to the recognized emotion. However, the voice recognition model may be manually changed When the voice recognition model is manually changed, for example, the computer receives the change input, and the control part converts voices into texts using the changed voice recognition model regardless of the recognized emotion.

In addition, the present invention can be variously modified based on the configurations described in the claims, and those modifications are also included in the scope of the present invention.

Although embodiments of the present invention have been described and illustrated in detail, the disclosed embodiments are made for purposes of illustration and example only and not limitation. The scope of the present invention should be interpreted by terms of the appended claims

What is claimed is:

1. A conference support device comprising:
a voice input part to which voice of a speaker among conference participants is input;
a storage part that stores a voice recognition model corresponding to human emotions;
a hardware processor that recognizes an emotion of the speaker and converts the voice of the speaker into a text using the voice recognition model corresponding to the recognized emotion; and
an output part that outputs the converted text.

2. The conference support device according to claim 1, further comprising:
a video input part into which a video obtained by photographing the conference participant is input, wherein
the hardware processor specifies the speaker from the video, and
recognizes the emotion of the specified speaker.

3. The conference support device according to claim 2, wherein
the hardware processor recognizes the emotion of the speaker from the video.

4. The conference support device according to claim 3, wherein
the hardware processor recognizes the emotion of the speaker from the video using a neural network.

5. The conference support device according to claim 3, wherein
the hardware processor recognizes the emotion from the video by using pattern matching for an action unit used in a facial expression description method.

6. The conference support device according to claim 1, wherein
the hardware processor recognizes the emotion of the speaker from the voice.

7. The conference support device according to claim 2, wherein
the hardware processor recognizes the emotion of the speaker from the video, and then recognizes the emotion of the speaker from the voice.

8. The conference support device according to claim 6, wherein
the hardware processor corrects a sound pressure level of the voice, and then recognizes the emotion of the speaker from the voice.

9. The conference support device according to claim 1, wherein
the hardware processor changes a conversion result from the voice to the text according to characteristics of a frequency of the voice.

10. The conference support device according to claim 1, wherein
the voice recognition model is an acoustic model and a language model corresponding to a plurality of emotions.

11. The conference support device according to claim 1, wherein
the storage part stores the voice recognition model corresponding to at least any two emotions of anger, disdain, disgust, fear, joy, neutrality, sadness, and surprise.

12. The conference support device according to claim 1, wherein
the hardware processor receives a change input of the voice recognition model from the conference participant and converts the voice into the text using the changed voice recognition model regardless of the recognized emotion.

13. A conference support system comprising:
the conference support device according to claim 1;
a microphone that is connected to a voice input part of the conference support device and collects a voice of a speaker; and
a display that is connected to an output part of the conference support device and displays a text.

14. A conference support system comprising:
the conference support device according to claim 2;
a microphone that is connected to a voice input part of the conference support device and collects a voice of a speaker;
a camera that is connected to a video input part of the conference support device and photographs the speaker; and
a display that is connected to an output part of the conference support device and displays a text.

15. A non-transitory recording medium storing a computer readable conference support program causing a computer to perform:
(a) collecting a voice of a speaker among conference participants;
(b) recognizing an emotion of the speaker; and
(c) converting the voice collected in the (a) into a text by using a voice recognition model corresponding to the emotion of the speaker recognized in the (a).

16. The non-transitory recording medium storing a computer readable conference support program according to claim 15, wherein in the (b), the speaker is specified from a video obtained by photographing the conference participants, and the emotion of the specified speaker is recognized

17. The non-transitory recording medium storing a computer readable conference support program according to claim 16, wherein
in the (b), the speaker is specified from the video, and the emotion of the specified speaker is recognized

18. The non-transitory recording medium storing a computer readable conference support program according to claim 16, wherein
in the (b), the emotion of the speaker is recognized from the video by using a neural network.

19. The non-transitory recording medium storing a computer readable conference support program according to claim 16, wherein
in the (b), the emotion is recognized from the video by using pattern matching for an action unit used in a facial expression description method.

20. The non-transitory recording medium storing a computer readable conference support program according to claim 15, wherein
in the (b), the emotion of the speaker is recognized from the voice.

21. The non-transitory recording medium storing a computer readable conference support program according to claim 16, wherein
in the (b), the emotion of the speaker is recognized from the video, and then the emotion of the speaker is recognized from the voice.

22. The non-transitory recording medium storing a computer readable conference support program according to claim 15, wherein
in the (b), a conversion result from the voice to the text is changed according to characteristics of a frequency of the voice.

23. The non-transitory recording medium storing a computer readable conference support program according to claim 15, wherein
the voice recognition model is an acoustic model and a language model corresponding to a plurality of emotions.

24. The non-transitory recording medium storing a computer readable conference support program according to claim 15, wherein
the voice recognition model corresponds to at least any two emotions of anger, disdain, disgust, fear, joy, neutrality, sadness, and surprise.
